(19) United States
(12) Patent Application Publication
(10) Pub. No.: US 2022/0343437 A1
(43) Pub. Date: Oct. 27, 2022

(54) SYSTEMS AND METHODS FOR CROWD SOURCED CONTENT MODERATION IN A COMMUNICATION PLATFORM THAT ALLOWS MONETIZATION BASED ON A SCORE

(71) Applicant: THROW APP CO., San Diego, CA (US)

(72) Inventor: Luis Fernando Amodio Giombini, San Diego, CA (US)

(21) Appl. No.: 17/727,478

(22) Filed: Apr. 22, 2022

Related U.S. Application Data
(60) Provisional application No. 63/178,311, filed on Apr. 22, 2021.
(60) Provisional application No. 63/178,324, filed on Apr. 22, 2021.
(60) Provisional application No. 63/178,330, filed on Apr. 22, 2021.
(60) Provisional application No. 63/194,685, filed on May 28, 2021.
(60) Provisional application No. 63/213,144, filed on Jun. 21, 2021.

(51) Int. Cl. G06Q 50/00; G06Q 10/06

(52) U.S. Cl. CPC G06Q 50/01; G06Q 10/063112; G06Q 10/06398

(57) ABSTRACT

A method comprising using at least one hardware processor to: generate a que of users willing to respond to queries; receive a query and a required number of responses from an application; and assign from the que a plurality of users to respond to the query, wherein the number of the plurality of users is based on the required number of responses and wherein the users are assigned based on a score that is indicative of a quality determination of prior responses for each of the plurality of users, wherein the quality determination is based at least in part on crowd sourced feedback including: delivering a throw or a response to a user; receiving form, the user an election to make a report; receiving an indication of what was offensive or objectionable.

### CROSS-REFERENCE APPLICATIONS

This application claims priority to U.S. Provisional Application No. 63/178,311, filed on Apr. 22, 2021, U.S. Provisional Application No. 63/178,324, filed on Apr. 22, 2021, U.S. Provisional Application No. 63/178,330, filed on Apr. 22, 2021, U.S. Provisional Application No. 63/194,685, filed on May 28, 2021 and U.S. Provisional Application No. 63/213,144, filed on Jun. 21, 2021, all the contents of the aforementioned applications are incorporated by reference herein in their entirety.

### BACKGROUND

### Field

The embodiments described herein are generally directed to communication platform, and, more particularly, to a communication platform in which users can earn money for providing responses.

### Description of the Related Art

Conventional social media platforms do not have effective means for promoting quality content by allowing users to monetize their interactions based on the quality of the content they post or provide.

### SUMMARY

Accordingly, systems, methods, and non-transitory computer-readable media are disclosed for a communication platform that allows users to monetize their participation with in a community. Within the platform, users can post queries, referred to as throws and request responses. Other users can catch the throws and provide responses. The thrower compensates each catcher for the response, where the opportunity to catch throws and the monetary compensation can be increased based on the catchers' score, which is in turn based on the quality of the responses.

According to one aspect, a method comprises using at least one hardware processor to: generate a que of users willing to respond to queries; receive a query and a required number of responses from an application; and assign from the que a plurality of users to respond to the query, wherein the number of the plurality of users is based on the required number of responses and wherein the users are assigned based on a score that is indicative of a quality determination of prior responses for each of the plurality of users. The method may be embodied in executable software modules of a processor-based system, such as a server, and/or in executable instructions stored in a non-transitory computer-readable medium.

### BRIEF DESCRIPTION OF THE DRAWINGS

The details of the present invention, both as to its structure and operation, may be gleaned in part by study of the accompanying drawings, in which like reference numerals refer to like parts, and in which:

FIG. 1 illustrates an example infrastructure, in which one or more of the processes described herein, may be implemented, according to an embodiment;

FIG. 2 illustrates an example processing system, by which one or more of the processes described herein, may be executed, according to an embodiment;

FIGS. 3-19 and 22 are screen shots illustrating a user interface for an application that can interface with a platform as illustrated in FIG. 1 to perform the functionality described, according to an embodiment;

FIG. 20 illustrates a que that can be implemented by the platform of FIG. 1, according to an embodiment;

FIG. 21 illustrates a multi-threaded que that can be implemented by the platform of FIG. 1, according to an embodiment;

FIG. 23 illustrated a process for moderating user content in the platform of FIG. 1, according to an embodiment; and

FIG. 24 illustrates scoring in the platform of FIG. 1, according to an embodiment.

### DETAILED DESCRIPTION

In an embodiment, systems, methods, and non-transitory computer-readable media are disclosed for a communication platform that allows users to monetize their participation with in a community.

After reading this description, it will become apparent to one skilled in the art how to implement the embodiments described in various alternative embodiments and alternative applications. However, although various embodiments will be described herein, it is understood that these embodiments are presented by way of example and illustration only, and not limitation. As such, this detailed description of various embodiments should not be construed to limit the scope or breadth of the present invention as set forth in the appended claims.

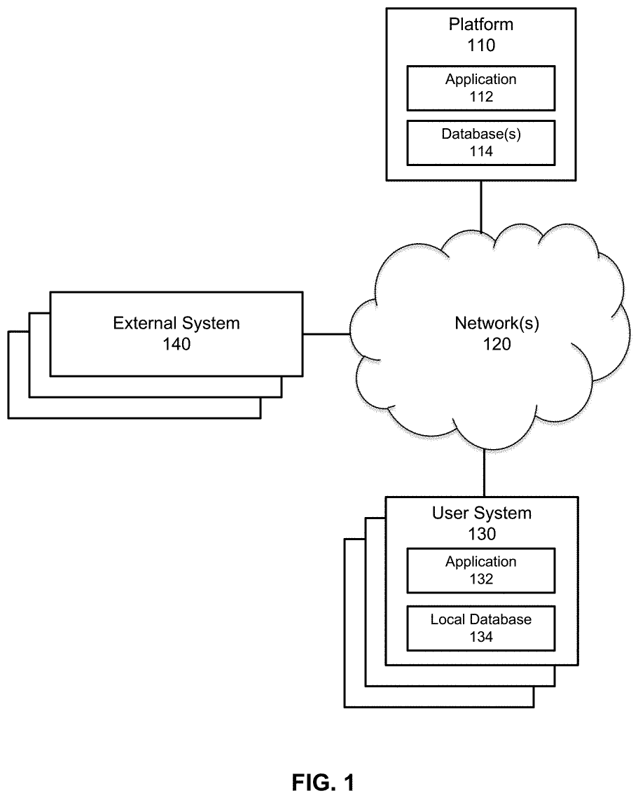

FIG. 1 illustrates an example infrastructure in which one or more of the disclosed processes can be implemented, according to an embodiment. The infrastructure may comprise a platform 110 (e.g., one or more servers) which hosts and/or executes one or more of the various functions, processes, methods, and/or software modules described herein. Platform 110 may comprise dedicated servers, or may instead comprise cloud instances, which utilize shared resources of one or more servers. These servers or cloud instances may be collocated and/or geographically distributed. Platform 110 may also comprise or be communicatively connected to a server application 112 and/or one or more databases 114. In addition, platform 110 may be communicatively connected to one or more user systems 130 via one or more networks 120. Platform 110 may also be communicatively connected to one or more external systems 140 (e.g., other platforms, websites, etc.) via one or more networks 120.

Network(s) 120 may comprise the Internet, and platform 110 may communicate with user system(s) 130 through the Internet using standard transmission protocols, such as HyperText Transfer Protocol (HTTP), HTTP Secure (HTTPS), File Transfer Protocol (FTP), FTP Secure (FTPS), Secure Shell FTP (SFTP), and the like, as well as proprietary protocols. While platform 110 is illustrated as being connected to various systems through a single set of network(s) 120, it should be understood that platform 110 may be connected to the various systems via different sets of one or more networks. For example, platform 110 may be connected to a subset of user systems 130 and/or external systems 140 via the Internet, but may be connected to one or more other user systems 130 and/or external systems 140 via an intranet. Furthermore, while only a few user systems 130 and external systems 140, one server application 112, and one set of database(s) 114 are illustrated, it should be understood that the infrastructure may comprise any number of user systems, external systems, server applications, and databases.

User system(s) 130 may comprise any type or types of computing devices capable of wired and/or wireless communication, including without limitation, desktop computers, laptop computers, tablet computers, smart phones or other mobile phones, servers, game consoles, televisions, set-top boxes, electronic kiosks, point-of-sale terminals, Automated Teller Machines, and/or the like.

Platform 110 may comprise web servers which host one or more websites and/or web services. In embodiments in which a website is provided, the website may comprise a graphical user interface, including, for example, one or more screens (e.g., webpages) generated in HyperText Markup Language (HTML) or other language. Platform 110 transmits or serves one or more screens of the graphical user interface in response to requests from user system(s) 130. In some embodiments, these screens may be served in the form of a wizard, in which case two or more screens may be served in a sequential manner, and one or more of the sequential screens may depend on an interaction of the user or user system 130 with one or more preceding screens. The requests to platform 110 and the responses from platform 110, including the screens of the graphical user interface, may both be communicated through network(s) 120, which may include the Internet, using standard communication protocols (e.g., HTTP, HTTPS, etc.). These screens (e.g., webpages) may comprise a combination of content and elements, such as text, images, videos, animations, references (e.g., hyperlinks), frames, inputs (e.g., textboxes, text areas, checkboxes, radio buttons, drop-down menus, buttons, forms, etc.), scripts (e.g., JavaScript), and the like, including elements comprising or derived from data stored in one or more databases (e.g., database(s) 114) that are locally and/or remotely accessible to platform 110. Platform 110 may also respond to other requests from user system(s) 130.

Platform 110 may further comprise, be communicatively coupled with, or otherwise have access to one or more database(s) 114. For example, platform 110 may comprise one or more database servers which manage one or more databases 114. A user system 130 or server application 112 executing on platform 110 may submit data (e.g., user data, form data, etc.) to be stored in database(s) 114, and/or request access to data stored in database(s) 114. Any suitable database may be utilized, including without limitation MySQL™, Oracle™ IBM™, Microsoft SQL™, Access™, PostgreSQL™, and the like, including cloud-based databases and proprietary databases. Data may be sent to platform 110, for instance, using the well-known POST request supported by HTTP, via FTP, and/or the like. This data, as well as other requests, may be handled, for example, by server-side web technology, such as a servlet or other software module (e.g., comprised in server application 112), executed by platform 110.

In embodiments in which a web service is provided, platform 110 may receive requests from external system(s) 140, and provide responses in eXtensible Markup Language (XML), JavaScript Object Notation (JSON), and/or any other suitable or desired format. In such embodiments, platform 110 may provide an application programming interface (API) which defines the manner in which user system(s) 130 and/or external system(s) 140 may interact with the web service. Thus, user system(s) 130 and/or external system(s) 140 (which may themselves be servers), can define their own user interfaces, and rely on the web service to implement or otherwise provide the backend processes, methods, functionality, storage, and/or the like, described herein. For example, in such an embodiment, a client application 132 executing on one or more user system(s) 130 may interact with a server application 112 executing on platform 110 to execute one or more or a portion of one or more of the various functions, processes, methods, and/or software modules described herein. Client application 132 may be “thin,” in which case processing is primarily carried out server-side by server application 112 on platform 110. A basic example of a thin client application 132 is a browser application, which simply requests, receives, and renders webpages at user system(s) 130, while server application 112 on platform 110 is responsible for generating the webpages and managing database functions. Alternatively, the client application may be “thick,” in which case processing is primarily carried out client-side by user system(s) 130. It should be understood that client application 132 may perform an amount of processing, relative to server application 112 on platform 110, at any point along this spectrum between “thin” and “thick,” depending on the design goals of the particular implementation. In any case, the application described herein, which may wholly reside on either platform 110 (e.g., in which case server application 112 performs all processing) or user system(s) 130 (e.g., in which case client application 132 performs all processing) or be distributed between platform 110 and user system(s) 130 (e.g., in which case server application 112 and client application 132 both perform processing), can comprise one or more executable software modules that implement one or more of the processes, methods, or functions of the application described herein.

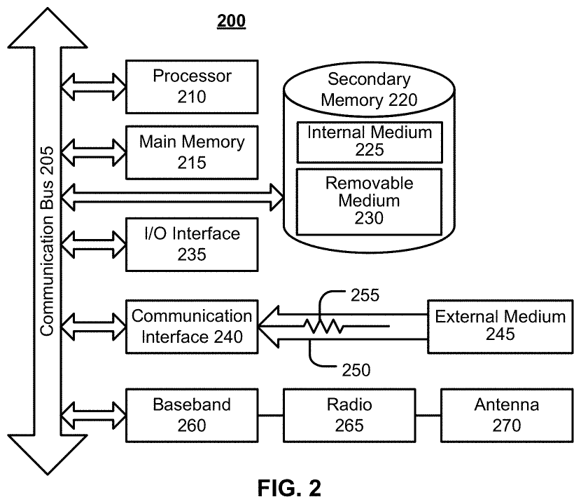

FIG. 2 is a block diagram illustrating an example wired or wireless system 200 that may be used in connection with various embodiments described herein. For example, system 200 may be used as or in conjunction with one or more of the functions, processes, or methods (e.g., to store and/or execute the application or one or more software modules of the application) described herein, and may represent components of platform 110, user system(s) 130, external system(s) 140, and/or other processing devices described herein. System 200 can be a server or any conventional personal computer, or any other processor-enabled device that is capable of wired or wireless data communication. Other computer systems and/or architectures may be also used, as will be clear to those skilled in the art.

System 200 preferably includes one or more processors, such as processor 210. Additional processors may be provided, such as an auxiliary processor to manage input/output, an auxiliary processor to perform floating-point mathematical operations, a special-purpose microprocessor having an architecture suitable for fast execution of signal-processing algorithms (e.g., digital-signal processor), a slave processor subordinate to the main processing system (e.g., back-end processor), an additional microprocessor or controller for dual or multiple processor systems, and/or a coprocessor. Such auxiliary processors may be discrete processors or may be integrated with processor 210. Examples of processors which may be used with system 200 include, without limitation, the Pentium® processor, Core i7® processor, and Xeon® processor, all of which are available from Intel Corporation of Santa Clara, Calif.

Processor 210 is preferably connected to a communication bus 205. Communication bus 205 may include a data channel for facilitating information transfer between storage and other peripheral components of system 200. Furthermore, communication bus 205 may provide a set of signals used for communication with processor 210, including a data bus, address bus, and/or control bus (not shown). Communication bus 205 may comprise any standard or non-standard bus architecture such as, for example, bus architectures compliant with industry standard architecture (ISA), extended industry standard architecture (EISA), Micro Channel Architecture (MCA), peripheral component interconnect (PCI) local bus, standards promulgated by the Institute of Electrical and Electronics Engineers (IEEE) including IEEE 488 general-purpose interface bus (GPM), IEEE 696/S-100, and/or the like.

System 200 preferably includes a main memory 215 and may also include a secondary memory 220. Main memory 215 provides storage of instructions and data for programs executing on processor 210, such as one or more of the functions and/or modules discussed herein. It should be understood that programs stored in the memory and executed by processor 210 may be written and/or compiled according to any suitable language, including without limitation C/C++, Java, JavaScript, Perl, Visual Basic, .NET, and the like. Main memory 215 is typically semiconductor-based memory such as dynamic random access memory (DRAM) and/or static random access memory (SRAM). Other semiconductor-based memory types include, for example, synchronous dynamic random access memory (SDRAM), Rambus dynamic random access memory (RDRAM), ferroelectric random access memory (FRAM), and the like, including read only memory (ROM).

Secondary memory 220 may optionally include an internal medium 225 and/or a removable medium 230. Removable medium 230 is read from and/or written to in any well-known manner. Removable storage medium 230 may be, for example, a magnetic tape drive, a compact disc (CD) drive, a digital versatile disc (DVD) drive, other optical drive, a flash memory drive, and/or the like.

Secondary memory 220 is a non-transitory computer-readable medium having computer-executable code (e.g., disclosed software modules) and/or other data stored thereon. The computer software or data stored on secondary memory 220 is read into main memory 215 for execution by processor 210.

In alternative embodiments, secondary memory 220 may include other similar means for allowing computer programs or other data or instructions to be loaded into system 200. Such means may include, for example, a communication interface 240, which allows software and data to be transferred from external storage medium 245 to system 200. Examples of external storage medium 245 may include an external hard disk drive, an external optical drive, an external magneto-optical drive, and/or the like. Other examples of secondary memory 220 may include semiconductor-based memory, such as programmable read-only memory (PROM), erasable programmable read-only memory (EPROM), electrically erasable read-only memory (EEPROM), and flash memory (block-oriented memory similar to EEPROM).

As mentioned above, system 200 may include a communication interface 240. Communication interface 240 allows software and data to be transferred between system 200 and external devices (e.g. printers), networks, or other information sources. For example, computer software or executable code may be transferred to system 200 from a network server (e.g., platform 110) via communication interface 240. Examples of communication interface 240 include a built-in network adapter, network interface card (NIC), Personal Computer Memory Card International Association (PCMCIA) network card, card bus network adapter, wireless network adapter, Universal Serial Bus (USB) network adapter, modem, a wireless data card, a communications port, an infrared interface, an IEEE 1394 fire-wire, and any other device capable of interfacing system 200 with a network (e.g., network(s) 120) or another computing device. Communication interface 240 preferably implements industry-promulgated protocol standards, such as Ethernet IEEE 802 standards, Fiber Channel, digital subscriber line (DSL), asynchronous digital subscriber line (ADSL), frame relay, asynchronous transfer mode (ATM), integrated digital services network (ISDN), personal communications services (PCS), transmission control protocol/Internet protocol (TCP/IP), serial line Internet protocol/point to point protocol (SLIP/PPP), and so on, but may also implement customized or non-standard interface protocols as well.

Software and data transferred via communication interface 240 are generally in the form of electrical communication signals 255. These signals 255 may be provided to communication interface 240 via a communication channel 250. In an embodiment, communication channel 250 may be a wired or wireless network (e.g., network(s) 120), or any variety of other communication links. Communication channel 250 carries signals 255 and can be implemented using a variety of wired or wireless communication means including wire or cable, fiber optics, conventional phone line, cellular phone link, wireless data communication link, radio frequency (“RF”) link, or infrared link, just to name a few.

Computer-executable code (e.g., computer programs, such as the disclosed application, or software modules) is stored in main memory 215 and/or secondary memory 220. Computer programs can also be received via communication interface 240 and stored in main memory 215 and/or secondary memory 220. Such computer programs, when executed, enable system 200 to perform the various functions of the disclosed embodiments as described elsewhere herein.

In this description, the term “computer-readable medium” is used to refer to any non-transitory computer-readable storage media used to provide computer-executable code and/or other data to or within system 200. Examples of such media include main memory 215, secondary memory 220 (including internal memory 225, removable medium 230, and external storage medium 245), and any peripheral device communicatively coupled with communication interface 240 (including a network information server or other network device). These non-transitory computer-readable media are means for providing executable code, programming instructions, software, and/or other data to system 200.

In an embodiment that is implemented using software, the software may be stored on a computer-readable medium and loaded into system 200 by way of removable medium 230, I/O interface 235, or communication interface 240. In such an embodiment, the software is loaded into system 200 in the form of electrical communication signals 255. The software, when executed by processor 210, preferably causes processor 210 to perform one or more of the processes and functions described elsewhere herein.

In an embodiment, I/O interface 235 provides an interface between one or more components of system 200 and one or more input and/or output devices. Example input devices include, without limitation, sensors, keyboards, touch screens or other touch-sensitive devices, biometric sensing devices, computer mice, trackballs, pen-based pointing devices, and/or the like. Examples of output devices include, without limitation, other processing devices, cathode ray tubes (CRTs), plasma displays, light-emitting diode (LED) displays, liquid crystal displays (LCDs), printers, vacuum fluorescent displays (VFDs), surface-conduction electron-emitter displays (SEDs), field emission displays (FEDs), and/or the like. In some cases, an input and output device may be combined, such as in the case of a touch panel display (e.g., in a smartphone, tablet, or other mobile device).

System 200 may also include optional wireless communication components that facilitate wireless communication over a voice network and/or a data network (e.g., in the case of user system 130). The wireless communication components comprise an antenna system 270, a radio system 265, and a baseband system 260. In system 200, radio frequency (RF) signals are transmitted and received over the air by antenna system 270 under the management of radio system 265.

In an embodiment, antenna system 270 may comprise one or more antennae and one or more multiplexors (not shown) that perform a switching function to provide antenna system 270 with transmit and receive signal paths. In the receive path, received RF signals can be coupled from a multiplexor to a low noise amplifier (not shown) that amplifies the received RF signal and sends the amplified signal to radio system 265.

In an alternative embodiment, radio system 265 may comprise one or more radios that are configured to communicate over various frequencies. In an embodiment, radio system 265 may combine a demodulator (not shown) and modulator (not shown) in one integrated circuit (IC). The demodulator and modulator can also be separate components. In the incoming path, the demodulator strips away the RF carrier signal leaving a baseband receive audio signal, which is sent from radio system 265 to baseband system 260.

If the received signal contains audio information, then baseband system 260 decodes the signal and converts it to an analog signal. Then the signal is amplified and sent to a speaker. Baseband system 260 also receives analog audio signals from a microphone. These analog audio signals are converted to digital signals and encoded by baseband system 260. Baseband system 260 also encodes the digital signals for transmission and generates a baseband transmit audio signal that is routed to the modulator portion of radio system 265. The modulator mixes the baseband transmit audio signal with an RF carrier signal, generating an RF transmit signal that is routed to antenna system 270 and may pass through a power amplifier (not shown). The power amplifier amplifies the RF transmit signal and routes it to antenna system 270, where the signal is switched to the antenna port for transmission.

Baseband system 260 is also communicatively coupled with processor 210, which may be a central processing unit (CPU). Processor 210 has access to data storage areas 215 and 220. Processor 210 is preferably configured to execute instructions (i.e., computer programs, such as the disclosed application, or software modules) that can be stored in main memory 215 or secondary memory 220. Computer programs can also be received from baseband processor 260 and stored in main memory 210 or in secondary memory 220, or executed upon receipt. Such computer programs, when executed, enable system 200 to perform the various functions of the disclosed embodiments.

Embodiments of processes for a communication platform that allows users to monetize their participation with in a community will now be described in detail. It should be understood that the described processes may be embodied in one or more software modules that are executed by one or more hardware processors (e.g., processor 210), for example, as the application discussed herein (e.g., server application 112, client application 132, and/or a distributed application comprising both server application 112 and client application 132), which may be executed wholly by processor(s) of platform 110, wholly by processor(s) of user system(s) 130, or may be distributed across platform 110 and user system(s) 130, such that some portions or modules of the application are executed by platform 110 and other portions or modules of the application are executed by user system(s) 130. The described processes may be implemented as instructions represented in source code, object code, and/or machine code. These instructions may be executed directly by hardware processor(s) 210, or alternatively, may be executed by a virtual machine operating between the object code and hardware processors 210. In addition, the disclosed application may be built upon or interfaced with one or more existing systems.

Alternatively, the described processes may be implemented as a hardware component (e.g., general-purpose processor, integrated circuit (IC), application-specific integrated circuit (ASIC), digital signal processor (DSP), field-programmable gate array (FPGA) or other programmable logic device, discrete gate or transistor logic, etc.), combination of hardware components, or combination of hardware and software components. To clearly illustrate the interchangeability of hardware and software, various illustrative components, blocks, modules, circuits, and steps are described herein generally in terms of their functionality. Whether such functionality is implemented as hardware or software depends upon the particular application and design constraints imposed on the overall system. Skilled persons can implement the described functionality in varying ways for each particular application, but such implementation decisions should not be interpreted as causing a departure from the scope of the invention. In addition, the grouping of functions within a component, block, module, circuit, or step is for ease of description. Specific functions or steps can be moved from one component, block, module, circuit, or step to another without departing from the invention.

Furthermore, while the processes, described herein, are illustrated with a certain arrangement and ordering of subprocesses, each process may be implemented with fewer, more, or different subprocesses and a different arrangement and/or ordering of subprocesses. In addition, it should be understood that any subprocess, which does not depend on the completion of another subprocess, may be executed before, after, or in parallel with that other independent subprocess, even if the subprocesses are described or illustrated in a particular order.

In the communication platform described herein, users can throw messages and catch massages. Throwers generate messages or content for which they would like a response. As noted below, the throws and the responses can be in various formats. Catchers can earn money for providing response. The more responses they provide, i.e., the more throws they catch, the more they make. Also, in certain embodiments, the higher rated their responses are, the more they can make. Moreover, in certain embodiments the activity level and rating can result in increased opportunity, or priority to catch throws. All of this will be described below.

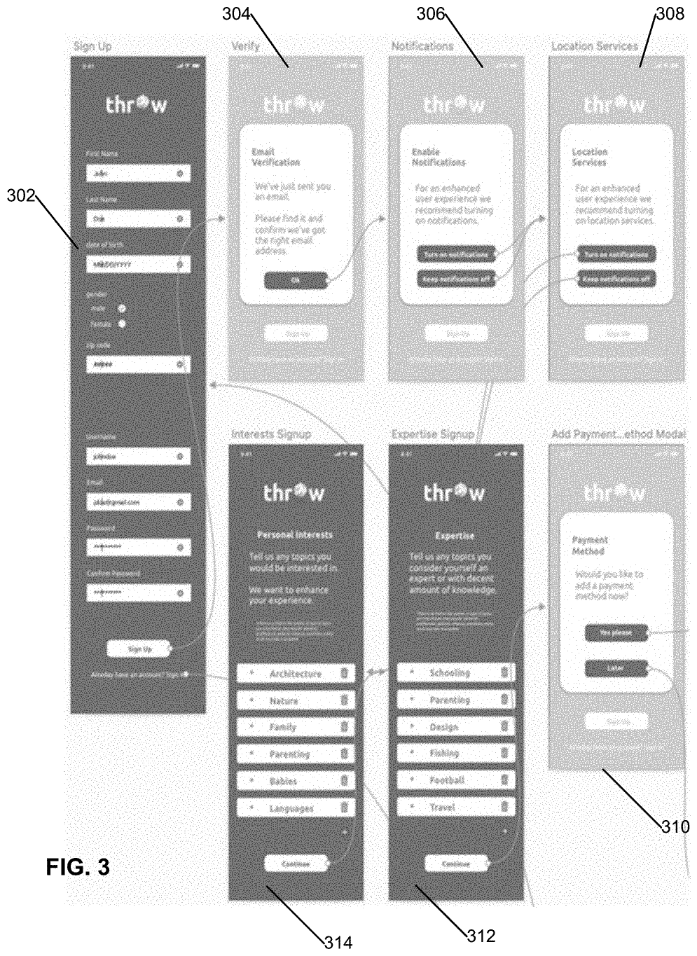

FIG. 3 are screen shots illustrating an initial sign up process for users to access the communication platform described herein. As can be seen in screen 302, the user can provide name, date of birth, gender, zip code, username, email, and set up a password. The goal is to collect only the necessary information from the user in this first signup in order to maximize user adoption. It will be understood that more or less information can be obtained at this sign up stage. Email should be verified as illustrated in screen shot 304 before a user can throw or catch. In certain embodiments, notifications must be requested and suggested although they will not be mandatory. Thus, as illustrated in the screen shot of FIG. 306, the user can accept or reject notifications. Location services can be required, at least while using the app, in order to gather information on where users are using the application and to possible inform the algorithms that match throwers with catchers. Thus, as illustrated by screen shot 308, the user can elect to enable or disable location services. Also, as illustrated in the screen shot of FIG. 310, the user must also be prompted to add payment method(s) but may opt to do it later.

A key aspect of the platform described herein is to provide a curated and very precise audience matching based on a user's personal interests, expertise and knowledge. To enable this feature, users are encouraged to specify what topics they are interested in, have expertise with respect to, and/or are knowledgeable on as illustrated in screen shots 312 and 314.

The information gathered can be used to generate an initial profile; however, the user will be able to add or remove topics by going to a settings menu. With time and artificial intelligence/machine learning the database of user interests and expertise can be made more robust, sophisticated and intelligent.

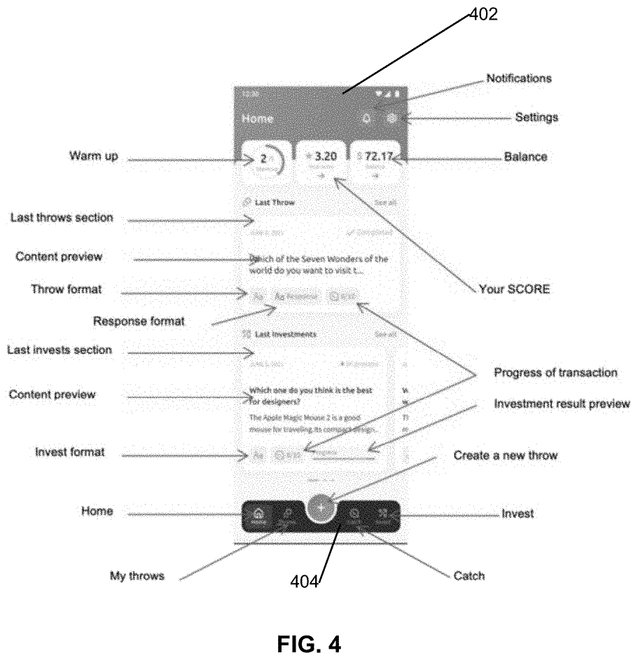

Screen shot 402 in FIG. 4 is an example of a main or home screen and is where the user can be taken once having logged on, and after having created an account. It is in screen 402 that the user can see your warm up status. In certain embodiments, for a user to start earning money, he/she must successfully catch and respond to a minimum, e.g., 5 throws without remuneration. Once the minimum is met, the user can start earning for each successful catch and response. All Base Catches can be automatically reset to 0 after 24 h of inactivity.

The user can also see their SCORE, which is described below, and their balance, which is also described below.

Below the display of this information, there can be a space where, e.g., 4 cards may be horizontally scrolled to show and summarize important information about the last, e.g., 4 throws (one on each card) a user has thrown. This “Last Throws Section” can include the throw and response formats, again more on this below, a preview of the content, and the progress of each throw. Of course, the number of cards can be more or less, e.g., all in progress throws, etc.

In the example of screen 402, there is a space below the Last Throw Section, where, e.g., 4 cards may be horizontally scrolled to show and summarize important information about the last, e.g., 4 investments (one on each card) a user has invested. As can be seen, this “Last Investment Section” can show a content preview, the invest format, the progress of the investment and the result preview.

At the very bottom of this example screen 402 there is a bottom navigation bar 404 that provides five options. From left to right 1) is “Home” which will bring the user back to the home screen from any other screen, 2) “Throws” will take you to a screen that will provide a feed with all throws a user has thrown with the possibility to filter from throws that are in process and that have been completed, 3) “+” (plus sign), for creating a “New Throw”, 4) “Catch” here the users will be able to receive throws from other users and respond to them, and finally 5) “Invest” where the users will have a feed with all the answers they have given and will be able to invest on them with the objective to promote his/her positive activity and in return improve their SCORE (described below).

The various formats for throws and responses can include video, such that users can either record what to send or select a video from their library. In certain embodiments the user is also able to add text, emojis, etc. on top of the video. This format can be both in throws and responses. An image format can also be included that allows the user to send an image they take or that is in their library, e.g., with text, emojis, etc. on top of the image. This format can also be both in throws and responses. The user can also have the ability to simply send a “text” message. There should be a character limit. This format may be both in throws and responses.

Other formats that can be used include a voice format that allows them to record and send an audio. There can be a length limit of 90 seconds. This format may be both in throws and responses. Poll: In this option, users will be able to select whether to throw a text poll or an image poll. An automatic shuffling of the options may be required to avoid order bias on responses. This format may only be used in throws. Multiple Option: Similar to the poll but in this case the user may only enter text options where the respondent may select one or several option on his/her answer. An automatic shuffling of the options will be required to avoid order bias on responses. This format may only be used in throws. Unordered list: Here the user can enter a series of options with no particular order. The respondent will have to organize the list according to the order that best makes sense to him/her. An automatic shuffling of the options will be required to avoid order bias on responses. This format may only be used in throws. Results: This stands for the results either for polls or multiple answer throws. Ordered List: This is the equivalent of the results for the Unordered List where the user will get a list with the items in the most popular order also showing how popular was each answer.

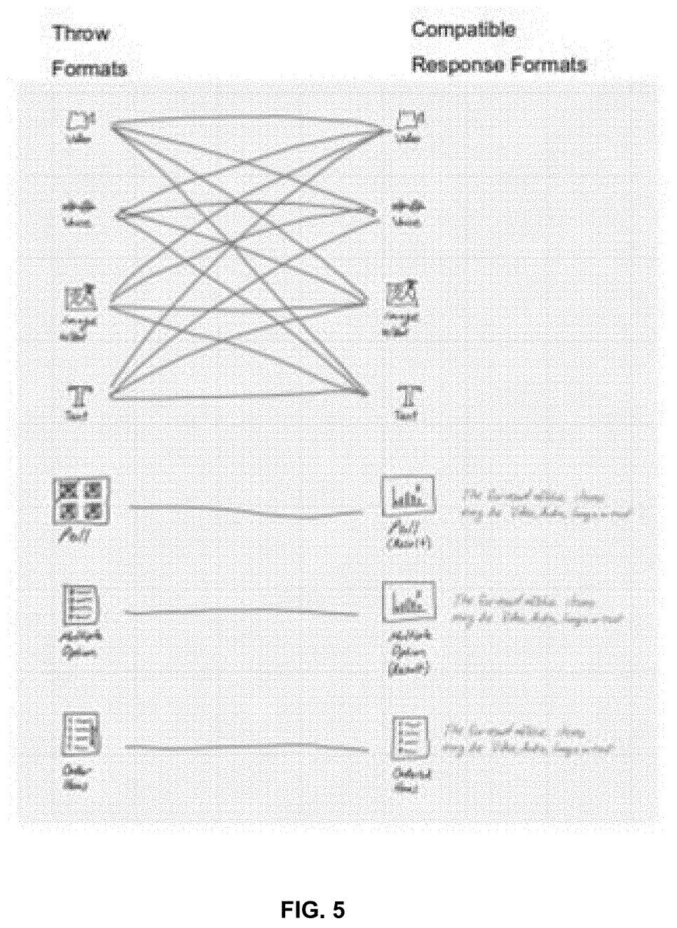

FIG. 5 illustrates how the formats can be intermingled for throws and catch responses.

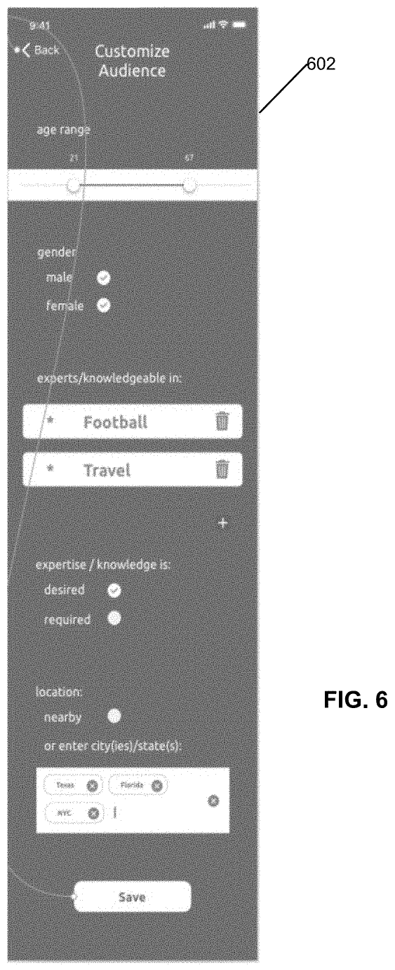

The user can customize the audience as illustrated in screen 602 of FIG. 6. Here users will have the capability of selecting and refining the target audience they want to get responses from. Among the preferences that may be selected are: age range; gender; personality; expertise and knowledgeability on certain topic(s) (one may also choose if this is a desirable or mandatory characteristic on respondents); choose to get answers from people on certain locations. For example, the user can be allowed to select the “Nearby” feature or type cities and/or states as criteria.

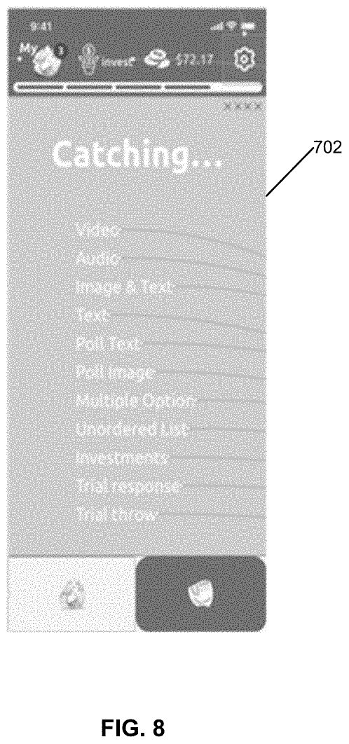

If the user selects the Catch Toggle icon in screen 402, they can be taken to catch screen 702 as illustrated in FIG. 7. In certain embodiments, in order for the user to be able to catch, he/she must first complete his/her profile. In example screen 702 both the top and bottom navigation bars are exactly the same as in the catch screen. The rest of the screen should have some sort of a splash screen with some animation that lets the user know that its “Catching” (fetching) throws. If for some reason, there are no throws to catch there should be a message that there are no throws to catch at the moment and to check back in a few moments. In such case it should also have a button to turn on notifications if the user doesn't have them on so that they can be notify when there are incoming throws. The user can also turn on push notifications so that we may notify him/her when there are incoming throws. If the fetching is successful, the user will be presented with a sequence of questions to answer until there are no more for that user to answer or that user decides to finish the session or sequence. The user will have the possibility to pass (not answer the question and continue to the next); however, there will be a limited number of “passes” or “don't know” that every user will be eligible for per day without hindering their SCORE, after consuming those it will take a toll on their SCORE.

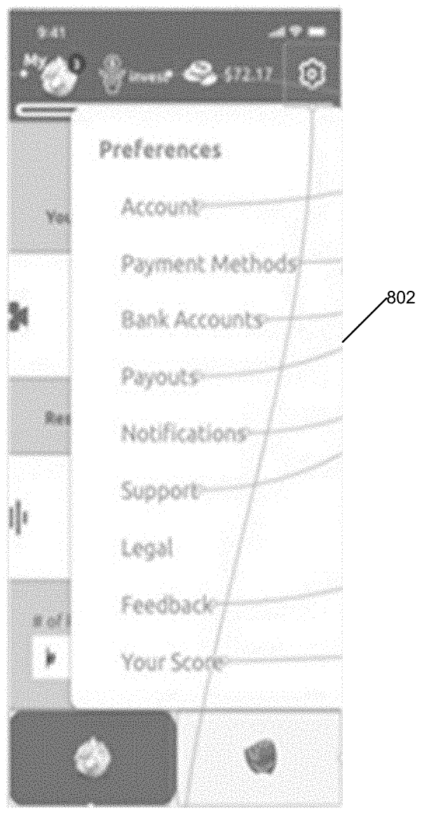

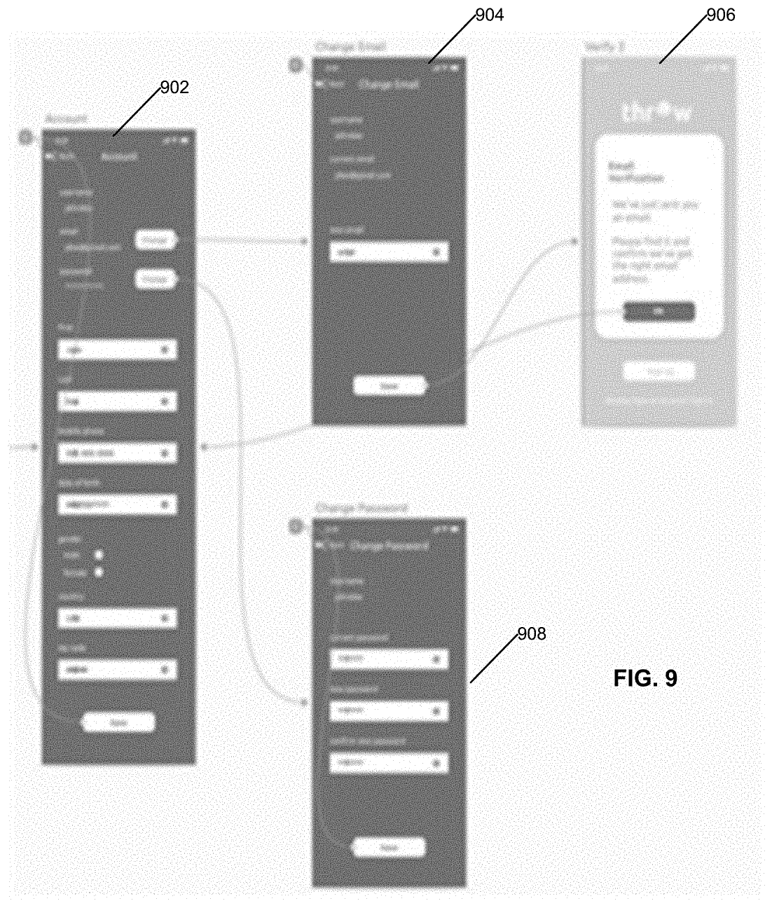

In this example, if the user selects the Preferences icon, then a sidebar menu 802 that slides in and out when clicked, as illustrated in FIG. 8. One item that can appear in the Preferences menu 802 is an account item. By selecting the account item, the user can be taken to the account screen 902, as illustrated in FIG. 9, which can show all the user's personal information and will allow the user to update email (screen 904) and re-verify (screen 906) it as well as changing the password (screen 908).

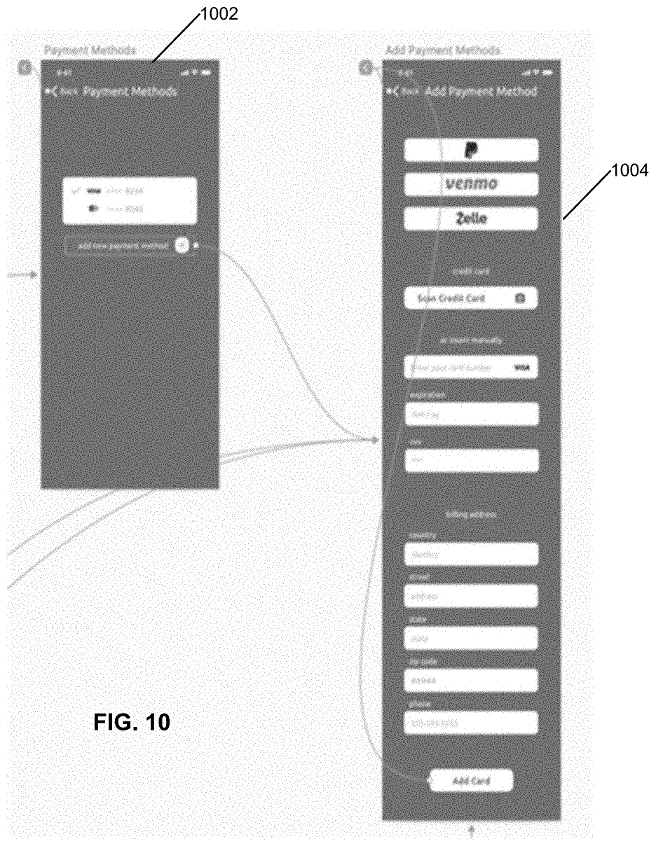

The payment methods item can take eth user to the payment methods screen 1002, as illustrated in FIG. 10, which can show the user the payment methods that he/she has added, and the app has on file and will give the option to select which one to use as default. Payments method screen 1002 should also have a button to add new payment methods (screen 1004). The add payment method screen 1004 should give the user the option to either connect with any or all of the three most popular payment applications, e.g., PayPal, Venmo and Zelle and also allow to add credit cards.

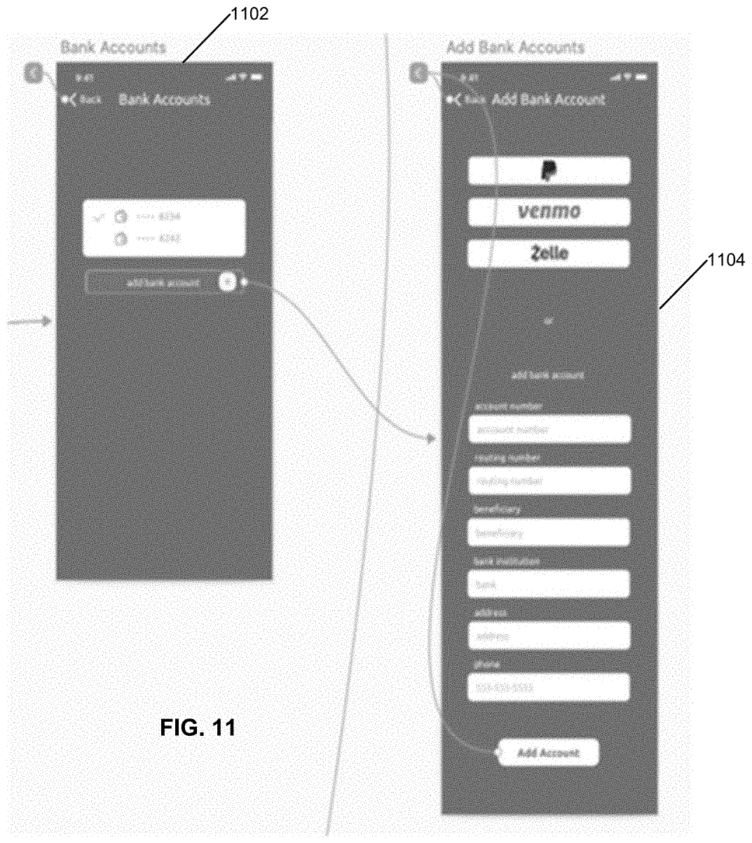

The bank account item in menu 802 can take the user to the bank accounts screen 1102, as illustrated in FIG. 11, which will show the user the bank accounts that he/she has added and the app has on file and can give the option to select which one to use as default. It must also have a button to add new bank accounts (screen 1104). The add bank account screen 1104 should give the user the option to either connect with any or all of the three most popular payment applications, e.g., PayPal, Venmo and Zelle and also allow to add a Bank Account.

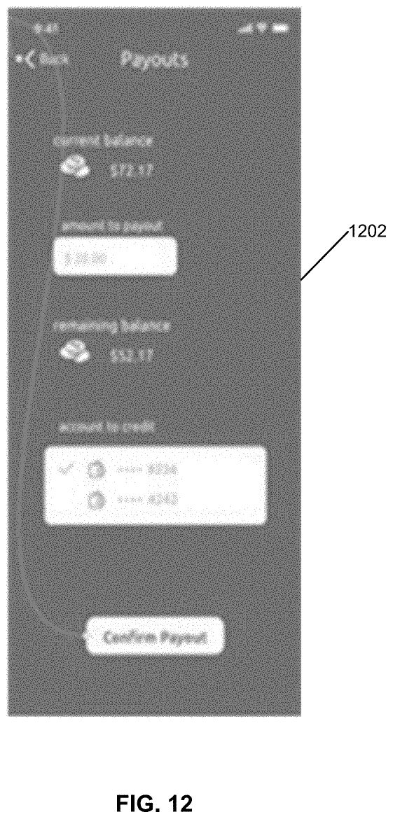

The payouts screen 1202, as illustrated in FIG. 12, can allow users to manage payouts from their wallet balance to any of their bank accounts.

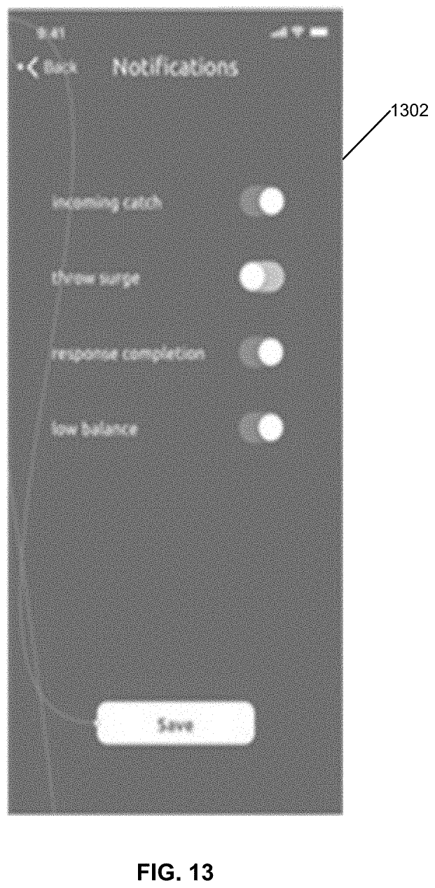

The notifications screen 1302, as illustrated in FIG. 13, can allow the user to turn on or off a series of push notifications. These notifications can for example let the user know when there are incoming throws to catch, when there is throw surge, when a throw he/she threw has been fully responded, when there is low balance in the wallet, etc.

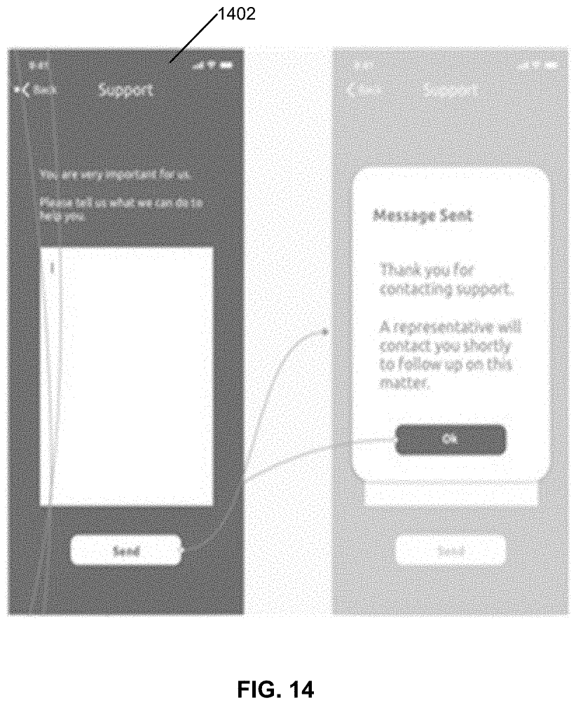

The support screen 1402, as illustrated in FIG. 14, allows the user to inquire on any issue or question to get support. This can be a key feature as a core aspect of this app is FEEDBACK. It is important that the user is able to rate if the feedback he/she is giving is positive, negative or neutral and there should be no limitation to explain himself/herself.

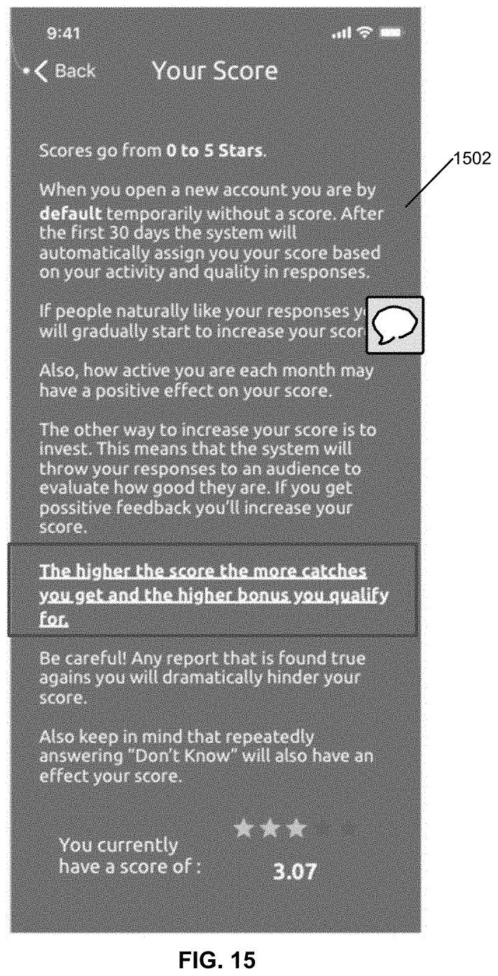

The “your score” screen 1502, as illustrated in FIG. 15, is where the scoring system can be explained to the user. As noted, the user's score goes up based on the user's activity and the quality of the responses provided. The quality of the responses can be measured by the throwers and other users. As explained below, the user can also “invest” in order to get their score up, which as also explained below will lead to more chances to respond and increased monetization.

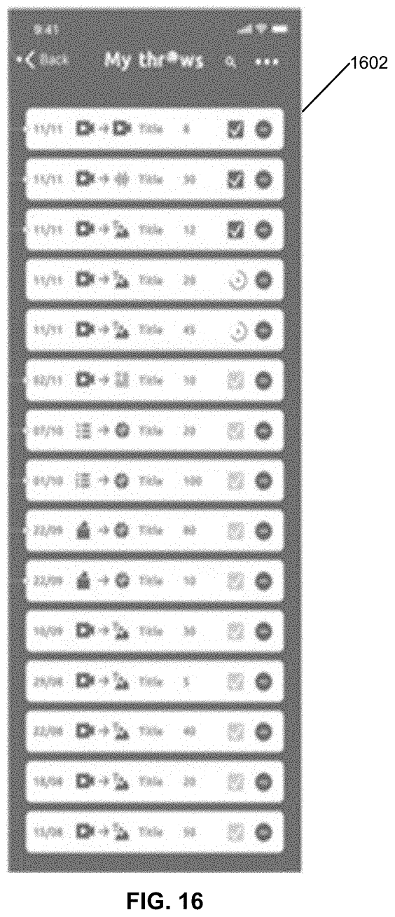

Referring back to screen 402, if the user selects the “my throws” icon, then they can be taken to screen 1602 as illustrated in FIG. 16. This is the screen where each user will keep track of his/her throws and the respective responses. After throwing something, the server will be fetching catchers' responses yet immediately the throw will be registered on this screen 1602 as if it were an order. The whole screen 1602 will have a list of orders organized “most recent” at the top “oldest” at the bottom and each order will have the following quick information for ease of use and identification.

The following can be presented for each throw: date of throw; format of throw; format of responses; title; number of responses; status (completed and reviewed by user, in process, completed and not reviewed by user); and delete order status. When the user selects any of the orders, he/she will be taken to a screen particular to that order where all responses and results will be presented. Each response can have an IDENTIFIER NUMBER and a LIKE, an EXPORT and a REPORT (!) button. There can also be an option to show the content that was originally thrown. There can also be a simple search field in order to look for throws by date or title. A feature to lookup unread throws or to filter by other attributes can be included.

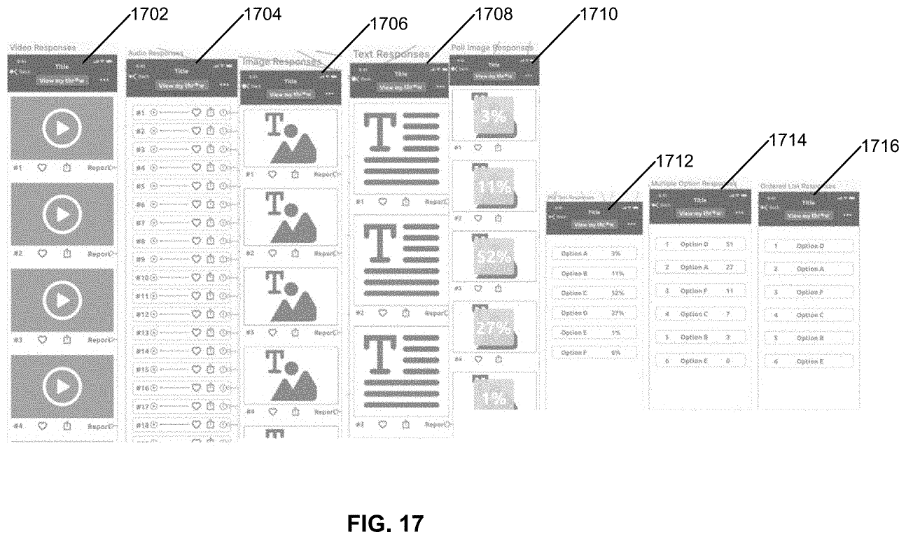

There can also be an options button in the navigation bar where the user can export all data in that order, delete the order or throw again that original throw as illustrated in screens 1702-1716, as illustrated in FIG. 17.

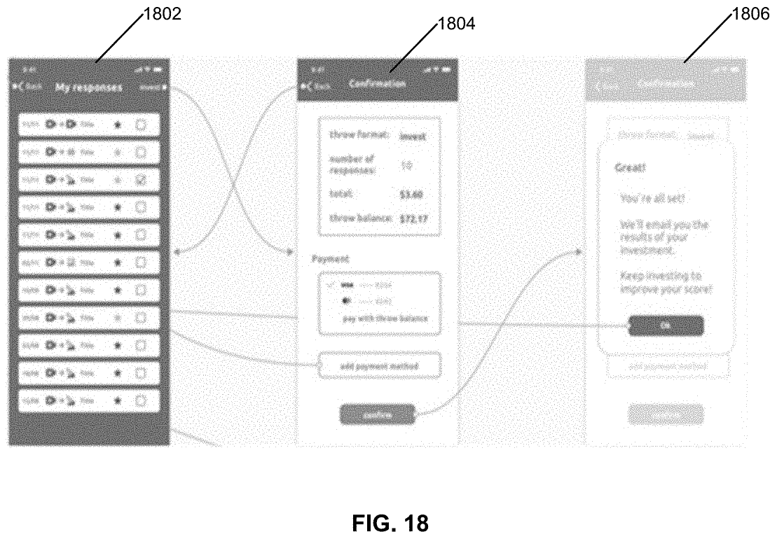

When clicking on the invest icon in screen 402, the user will be taken to a screen with a list of all his/her responses organized “most recent” at the top “oldest” at the bottom as illustrated in screen 1802 in FIG. 18. There each response can appear as an order similar to how it appears on “My Throws” with the difference that here the user can only see the original throw, the response he/she gave and each order will have the following quick information for ease of use and identification: date of throw/response; format of throw; format of responses; title; star (button for user to highlight a response as favorite); and checkbox to select which response(s) to invest on.

Once the user selects a response in which to invest, the user can be taken to a confirmation page (screen 1804) where they will be shown the details of the order, they will have the option to select payment method or add payment method and they may even pay with their wallet balance. Once confirmed (screen 1806), they will get a popup/modal message confirming and will then be sent back to the main screen. Once the invest “investigation” is complete, the user will get the results via email. In certain embodiments, each response may only be used for investment once. It cannot be reused several times. So once used, the checkmark on each order in the list will vanish or turn opaque and have no functionality/click once it has been used.

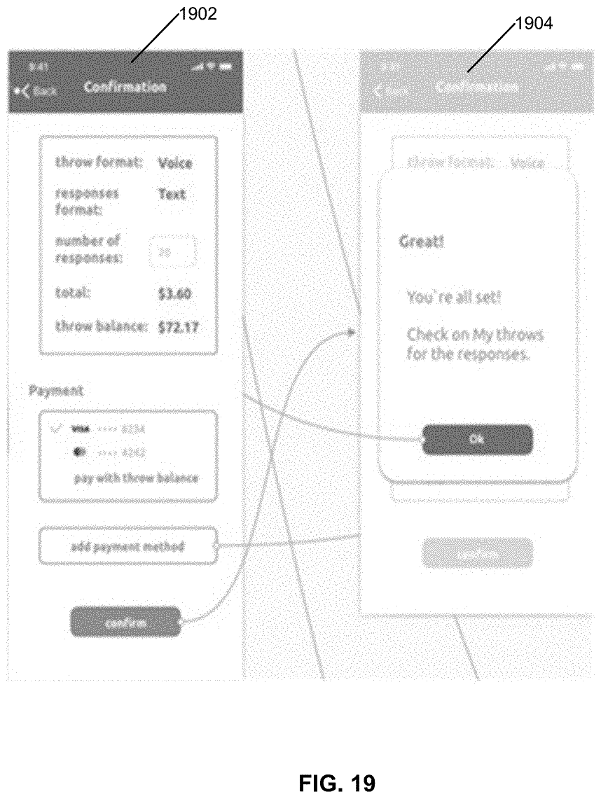

FIG. 19 illustrated example screens related to the throw process. It should be noted that the process is the same for the different type of formats. As illustrated by screen 1902, the user either inputs, captures or selects the media to attach from his/her library. Then the user is taken to a screen where he/she may review the selected content and add a caption/description where he/she may describe what he's asking for, or simply use it to complement the content. Then, the user is taken to a confirmation screen 1904 where all details of the transaction are summarized for final confirmation and payment method is selected. The user may select to pay with any of the accepted payment methods or with his/her wallet's balance. Finally, the user can be shown a confirmation prompt/modal and taken back to the main screen.

As soon as any user navigates to the catch screen the app will fetch throws. If the user is available, he/she can be assigned a throw. When this happens, the user will immediately start the Catch process flow. Catches can come in any of the formats mentioned earlier in this document (video, image with text, audio, text, poll, multiple option and unordered lists). In this scenario, the user will first see a screen where he/she may review the incoming throw. The catcher can see the title, the content that was thrown and the caption. Once reviewed, the catcher can click continue and will start a flow equivalent to the flow of a throw but on the precise format the user that requested the throw specified (so if a user sent a throw in audio and requested videos back, the catcher will then start a video flow to record his/her response).

After giving input, capturing or selecting the content from library for the response and going through the review screen, catcher will submit the response and can immediately be prompted with a message/modal confirming the successful response and show the new user wallet's balance. Then the catcher will be taken back to the catch screen.

On open ended questions (video, image w/text, audio and text formats only as poll, multiple question and unordered list the answers are provided) it is possible for a catcher to catch a throw of which he/she doesn't know the answer or simply doesn't feel like answering that query. In this case, the catcher will have the alternative to click on the “don't know” or “pass” options, which will rethrow that query to somebody else; however, there should be a limited number of “free don't knows” or “passes” a month, after consuming those “don't knows” the score of that user should start being affected. After consuming all the passes that user will simply not be able to pass any more, e.g., such a button would appear dim.

Thus, after users have registered and caught a certain minimum number of throws, they can begin to monetize their use of the application. As is at least partially illustrated in FIG. 19, throwers, i.e., users who want to get responses to something, i.e., an issue they are facing, something they are wondering about, a poll, etc., they can create a throw using the formats described above, indicate a format(s) for the responses, and designate a number of responses being sought. Each response can be associated with a monetary reward paid by the thrower, from the thrower's account set up in the application. When a catcher provides a response, their account can be credited the appropriate amount.

A que can be used to manage the assignment of responses, or at least the opportunity to respond. The que can be first come first served. But in other implementations, users that are online and catching (fetching for incoming throws) can be queued based on their score. For example, the user with the higher score can be at the top of the que and can receive the first available throw, the one with the second highest score can be the next in line and so forth. The moment a new user comes online and catches he/she will immediately be placed in line according to his/her score, although the process for new users are described in more detail below. In case of equal scores, a first come first served rule can apply.

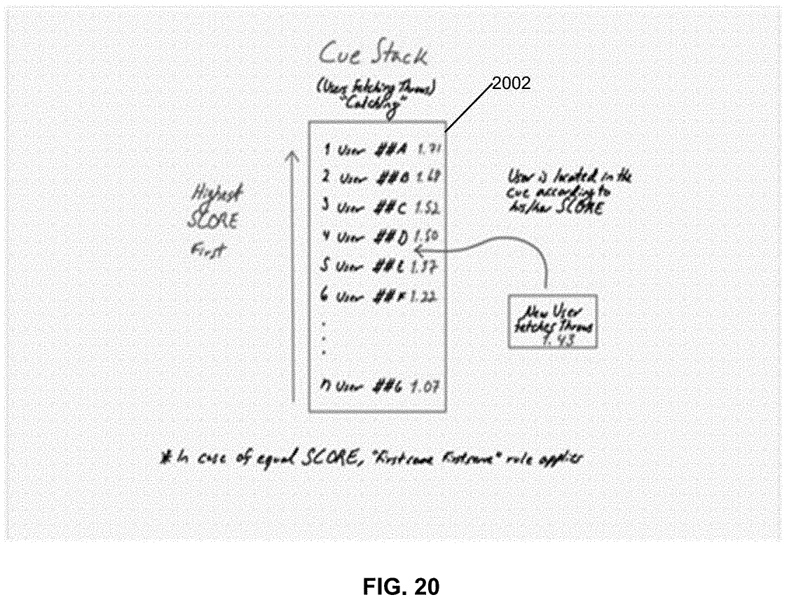

An example que 2002 is illustrated in FIG. 20. As can be seen, the users are sorted with the higher scored users at the top. New users can be inserted into the que, based on where their score falls. As referenced above, users can indicate when they want to be available to catch, so they know when they should be monitoring for throws and to control when they are available. In other embodiments, a timer can be used and if a user does not catch a throw within a certain period of time, it becomes available to the next user in the que. Although, there are limitations to this approach as noted below.

When a user first joins, he/she will not initially have a score and thus a score will need to be assigned. Assigning a score that is too high or low will be unfair to the rest of the users but assigning a mediocre score may discourage the new user. Also, if the new users are given an intermediate number, they are not going to have a good first experience because they might feel they don't receive enough throws and may abandon the platform. In the interest of encourage users to be proactive at first, then they need to be given the opportunity to set their starting “score” objectively. Alternatively, the system can be configured to, e.g., periodically feed a new user throws, so they can respond and start building a score. This can require a separate cue that manages unrated newcomers and that can work on a first-come first-serve basis.

Once a catcher responds to a throw, that catcher should not be allowed to answer that same query a second time even if he/she jumps back in to the que and is the first in line. The que should be controlled such that the catch will go to the first in line provided that he/she hasn't answered that query before.

In certain embodiments, where there is a large volume of multi-threaded ques may be required to maintain seamless and timely responses as throws come in. It must be kept in mind that a goal of the platform can be to reward those users with the highest scores by giving them more opportunities to monetize their interaction with the application, i.e., more opportunities to catch throws. Thus, in one embodiments, there can be a single que as described above. If a user requests 12 responses, then the first 12 catchers get the opportunity and when they are done responding, they go back to the que and the next throw is made available. But this can obviously slow things down as everything has to wait until those 12 catchers are done responding. Moreover, what if a thrower asks for 100 responses? It should be apparent that the system can bog down quickly. Such an embodiment would certainly need a time limit for responses, although this can be implemented regardless.

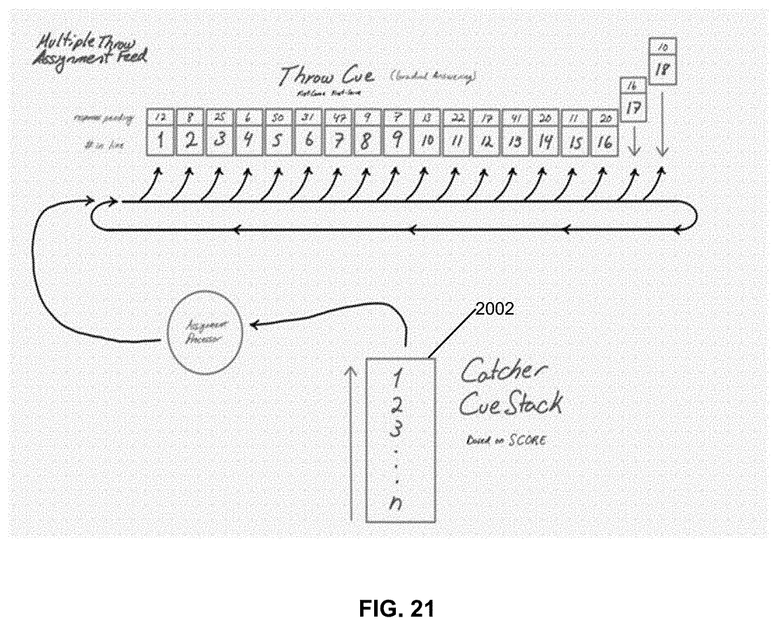

Alternatively, a multi-threaded que can be used as illustrated in FIG. 21. As can be seen, catchers in que 2002 are assigned to throws as the come in. When a catcher is done responding they re-enter the que and get assigned another throw. This can be done multiple ways: If the first throw requires 12 responses, catchers 1-12 can be assigned and then catchers 13-20 can be assigned to the next and so on. Alternatively, as illustrated, catcher 1 can be assigned to the first throw, catcher 2 to the next and so on, with the thread “scanning back and forth until all throws have the requisite number of catchers.

It should also be noted that in certain embodiments users can customize the audience and/or various demographic and other data can be used to match throwers and catchers. This will obviously complicate management of the que(ues). In this case, e.g., a catcher can be virtually available in several different cues or new cues can be created depending on the customization.

In certain embodiments, geolocation can be used to gather geographical data to determine where users are using the application, which can be used of matching throwers and catchers as well as for statistics and growth strategy.

Content moderation can be key as it is with any social media platform. With the large amount of traffic that can occur on the platform and the need for a seamless and efficient processing of throws, it is not feasible for the platform to be used to monitor every throw and every response for content that is not appropriate. Thus, in certain embodiments, crowdsourcing user opinions can be used to monitor content. When a user catches a throw, or a thrower receives a response, a button or icon can be included that allows the user to report the throw/user as having objectionable content or message as illustrated in screen 2102 in FIG. 21.

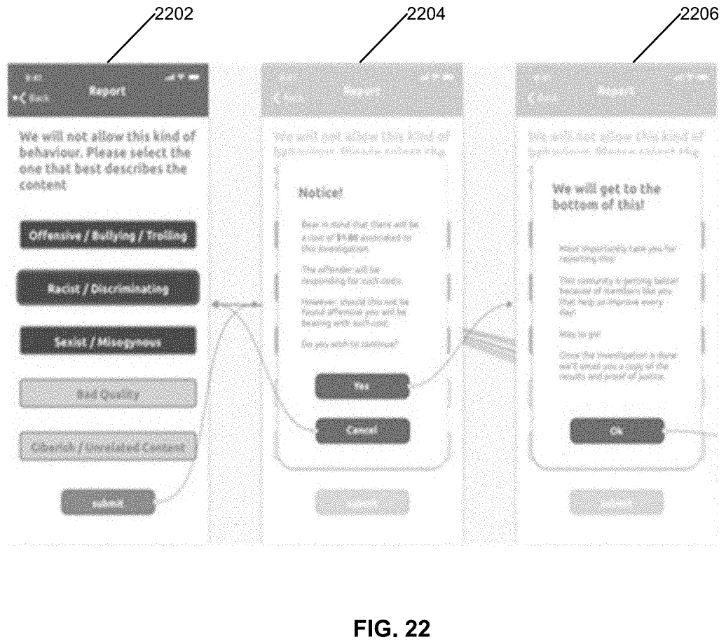

Once the user elects to make a report, they can then indicate what was offensive or objectionable, e.g., by selecting various objectionable categories that apply. But a mechanism to prevent over aggressive policing of content should also be implemented. In the example of FIG. 22, there is a cost associate with the report. If the report is made and substantiated, then the user being reported bears that cost. But if the report is not substantiated, the user making the report pays that cost. Thus, as illustrated in screen 2104, the user can be presented with this information and given the opportunity to proceed or not. If the user proceeds, then as illustrated in screen 2106, the report can be accepted and confirmed.

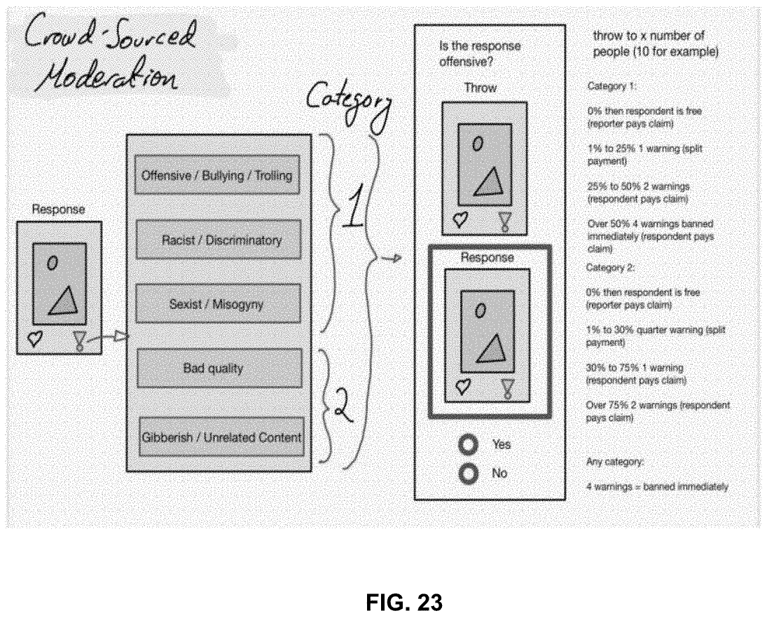

Once accepted, both the throw and the response can be presented to X number of users, possibly only catchers, and possibly only catchers with a score above a certain threshold. The users will then respond as to whether they find the throw or response an offense as well as illustrated in FIG. 23. If the report is confirmed, the offending user can pay for the associated charge, and can be given a count, e.g., as represented by the red X's in screen 402. In certain embodiments, once the user accumulates a certain number of counts, they can be banned from the platform.

The banning can come in tiers. For example, the offending user could be banned form monetizing by preventing them from catching, but they may still be allowed to throw. The ban can also be for a certain period, which can escalate and end in a permanent ban, if the user continues to get reported and the reports continue to be confirmed.

Content can also be reported if it is just poor. For example, the CATEGORY 1 OFFENSES can be considered any type of content or act that deliberately offends people, institutions, beliefs or that would be categorized as misconduct or unethical. For example, any content that is deemed, bullying, trolling, racism, discrimination, sexism, misogyny. CATEGORY 2 OFFENSES can be considered any type of content that is of bad quality, gibberish, copy-paste content, unrelated content, etc.

The platform can also promote and reward good content. For example, just as a report option or button can be included in content, a like button can as well. More likes can result in a higher score for the user. Also, in certain embodiments, a user can choose to invest in their responses. Any user can be able to select responses he/she has previously sent and submit the response for further “grading”. As with the investigation of offending or bad content, when the user submits a response in this manner, the throw and the response can be sent to a predetermined number of users, potentially just catchers, who will determine, e.g., whether the response is just regular, good or outstanding, which can then affect the user's score.

As noted above, using the “don't know” feature more times than the “free don't knows” that the platform may provide all users every month, can also negatively affect the user's score.

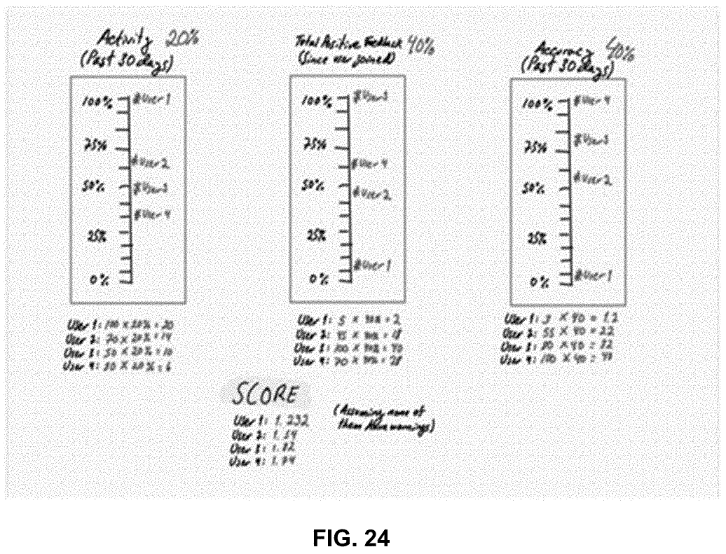

On the positive side, depending on the embodiment, several factors can impact the score, i.e.: 1) how much activity each user has, 2) how much positive feedback he/she has, e.g., both by natural likes or by investing, and 3) what percent of positive feedback the user has overall (# of positive feedbacks/# of total responses). In certain embodiments, these activities can be mapped and assigned a percentile. Thus, the user with most activity will have 100% in that dimension, all users below that will be assigned a percentile proportional to that 100%. As illustrated in FIG. 24. The impact of each activity can also be weighted.

Most metrics will be determined on a relative basis. This is by comparing all users' absolute values of that given metric and assigning them the corresponding relative value, e.g., a decimal value or float between 0 and 5, in comparison to all other users at that given point in time. Note: the high end of the float cannot be over 5 or under 0. In case the user's combination of warnings and “don't knows” compute a SCORE below 0 then that user's SCORE will be 0. As a simple example: If there were only 3 users, where their activity in the past 30 days was: user #1=40 hours, user #2=20 hours and user #3=5 hours (these are absolute values). Then the corresponding relative values for those users' activity would be as follows: user #1=1.00 (100%), user #2=0.50 (50%) and user #3=0.1250 (12.5%), and:

SCORE=[{(ACTIVITY*0.25)+(TPF*0.25)+(ACCURACY*0.25)+((1−“NEGATIVE CONTENT” factor)*0.25)}*5]−[(# of warnings)/2]−(“don't know” factor*3),

Where:

ACTIVITY: the relative value (compared to all other users) of a user's activity in the past, e.g., 2 days.

TPF: the relative value (compared to all other users) of how much overall positive feedback he/she has (either by natural LIKES or by INVESTING or both) since he/she joined.

ACCURACY: the relative value (compared to all other users) of what % of positive feedback the user has overall (Ex.: # of positive feedbacks in last 15 days/# of total responses in last 15 days).

“NEGATIVE CONTENT” factor: the relative value (compared to all other users) of the % of that user's total responses that have been tagged as “negative content” (Ex.: # of “negative content” tags since that user joined/# of total responses since that user joined).

And the “don't know” factor: the relative value (compared to all other users) of how many times he/she clicked the “don't know” button in the last, e.g., 72 hours.

And the # of warnings: number of warnings a given user has per the following table 1:

TABLE 1

| Category 1 | Category 2 |
|---|---|
| <30% → not guilty (0 warnings) | <30% → not guilty (0 warnings) |
| >=30% → guilty (2 warnings) | >=30% → guilty (1 warnings) |
| >=50% → guilty (3 warnings) | |
| >=70% → guilty (4 warnings) | |

Compensation can then be calculated as follow:

$$Compensation = BASE COMPENSATION + ( BONUS * BONUS FACTOR ) , where$$

$$BONUS FACTOR = \frac{\begin{matrix}( SCORE - ( AVERAGE SCORE * \\ ( 1 - ADJUSTMENT FACTOR ) ) )\end{matrix}}{( FLEXIBILITY FACTOR )} ;$$

$$AVERAGE SCORE = \frac{SUM OF ALL USERS ' SCORE}{TOTAL NUMBER OF USERS} ;$$

FLEXIBILITY FACTOR: factor used to adjust the curve of values, initially=3.50 by may vary in time;
and
ADJUSTMENT FACTOR: factor used to adjust the curve of values, initially=0.30 but may vary in time.

The platform is a place where all people and users must feel safe and that is why the moderation “trialing system” is implemented, which will guard against vicious and dangerous users and content. But positive and constructive feedback is also provided. For this we must have another indicator that must be considered in the rating algorithm where users will be affected in their SCORE if their responses are perceived negative, hater or malicious (yet not offensive). Even though it is a subjective measurement it is important to take in account so that catchers make their best effort to provide an insightful and positively intended response.

The above description of the disclosed embodiments is provided to enable any person skilled in the art to make or use the invention. Various modifications to these embodiments will be readily apparent to those skilled in the art, and the general principles described herein can be applied to other embodiments without departing from the spirit or scope of the invention. Thus, it is to be understood that the description and drawings presented herein represent a presently preferred embodiment of the invention and are therefore representative of the subject matter which is broadly contemplated by the present invention. It is further understood that the scope of the present invention fully encompasses other embodiments that may become obvious to those skilled in the art and that the scope of the present invention is accordingly not limited.

Combinations, described herein, such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, and any such combination may contain one or more members of its constituents A, B, and/or C. For example, a combination of A and B may comprise one A and multiple B's, multiple A's and one B, or multiple A's and multiple B's.

What is claimed is:

1. A method comprising using at least one hardware processor to:
generate a que of users willing to respond to queries;
receive a query and a required number of responses from an application; and
assign from the que a plurality of users to respond to the query, wherein the number of the plurality of users is based on the required number of responses and wherein the users are assigned based on a score that is indicative of a quality determination of prior responses for each of the plurality of users, wherein the quality determination is based at least in part on crowd sourced feedback including:
delivering a throw or a response to a user;
receiving form, the user an election to make a report;
receiving an indication of what was offensive or objectionable;
associating a cost with the report and presenting the cost to the user;
receiving a confirmation to proceed with the report from the user;
presenting the report to a plurality of users;
receiving a response from the plurality of users and determining whether the report has been validated based on the responses from the plurality of users; and
when the report is validated, lowering the score of a user being reported.

2. The method of claim 1, further comprising, when the report is validated, applying the cost to a user associated with the reported throw or response, and when the report is not validated applying the cost to the user that made the report.

3. The method of claim 1, wherein the plurality of users includes only users with a score over a threshold.

4. The method of claim 1, wherein the at least one hardware processor is further configured to monitor a number of validated reports and banning the user associated with the validated reports when the number of validated reports exceeds a threshold.

5. The method of claim 4, wherein the banning can come in tiers, including banning an offending user form monetizing by preventing them from catching, but still be allowing them to throw, or banning for escalating periods of time, including a complete ban.

6. The method of claim 1, wherein the score is determined using the following equation:
SCORE=[{(ACTIVITY*0.25)+(TPF*0.25)+(ACCURACY*0.25)+((1−“NEGATIVE CONTENT” factor)*0.25)}*5]−[(# of warnings)/2]−(“don't know” factor*3),
Where:
ACTIVITY: the relative value, compared to all other users, of a user's activity in an activity period;
TPF: the relative value, compared to all other users, of how much overall positive feedback during a TPF period;
ACCURACY: the relative value, compared to all other users, of what percent of positive feedback the user has overall for an accuracy period;
NEGATIVE CONTENT factor: the relative value, compared to all other users, of the percent of that user's total responses that have been tagged as “negative content” (the number of “negative content” tags since that user joined/the number of total responses since that user joined);
the “don't know” factor: the relative value (compared to all other users) of how many times he/she clicked the “don't know” button in in a certain time period; and
the number of warnings: number of warnings a given user has.

7. The method of claim 1, wherein the activity period is 2 days.

8. The method of claim 1, wherein the TPF period is since a user has joined.

9. The method of claim 1, wherein the positive feedback can comprise at least one of LIKES or INVESTING.

10. The method of claim 1, wherein the accuracy period is 15 days.

11. The method of claim 1, wherein the relative value for the NEGATIVE CONTENT is determined as the number of positive feedbacks during the accuracy period/the number of total responses in the accuracy period.

12. The method of claim 1, wherein the relative value for the NEGATIVE CONTENT is determined as the number of “negative content” tags during a negative content period/the number of total responses during the negative content period.

13. The method of claim 1, wherein the number of warnings is broken down by category.

14. The method of claim 13, wherein the categories can include CATEGORY 1 OFFENSES, which is any type of content or act that deliberately offends people, institutions, beliefs or that would be categorized as misconduct or unethical.

15. The method of claim 13, wherein the categories can include CATEGORY 2 OFFENSES, which is any type of content considered of bad quality, gibberish, copy-paste content, or unrelated content.
